(19) United States
(12) Patent Application Publication
(10) Pub. No.: US 2024/0228373 A1
(43) Pub. Date: Jul. 11, 2024

(54) DECARBONATION PROCESS OF CARBONATED MATERIALS IN A MULTI-SHAFT VERTICAL KILN

(71) Applicant: TECFORLIME, Louvain-la-Neuve (BE)

(72) Inventors: Etienne THIBEAUMONT, Villers-le-Bouillet (BE); Alex AUBERT, Ganshoren (BE); Pierre-Olivier CAMBIER, Hamme-Mille (BE); Charles ROBIN, Faulx-Les-Tombes (BE)

(21) Appl. No.: 18/560,332

(22) PCT Filed: May 10, 2022
(86) PCT No.: PCT/EP2022/062608

§ 371 Date: Nov. 10, 2023

(30) Foreign Application Priority Data
May 11, 2021 (EP) 21173257.3
May 11, 2021 (EP) 21173263.1
Sep. 16, 2021 (EP) 21197037.1
Sep. 16, 2021 (EP) 21197039.7
Dec. 13, 2021 (EP) 21214128.7

(51) Int. Cl. C04B 2/12

(52) U.S. Cl. CPC C04B 2/12

(57) ABSTRACT

The present disclosure relates to a decarbonation process of carbonated materials, in particular limestone and dolomitic limestone, with CO₂ recovery in a multi-shaft vertical kiln (MSVK) comprising a first and a second shaft with preheating, heating and cooling zones and a cross-over channel between each shaft. The method includes alternately heating carbonated materials by a combustion of at least one fuel with at least one comburent, up to a temperature range in which carbon dioxide of the carbonated materials is released, the combustion of the fuel and the decarbonation generating an exhaust gas. Decarbonated materials are cooled in the cooling zones with one or more cooling streams. The process further includes extracting the exhaust gas from the multi-shaft vertical kiln and feeding a buffer with the extracted exhaust gas.

### TECHNICAL FIELD

The present disclosure relates to a decarbonation process of carbonated materials and to a multi-shaft vertical kiln for carrying said process.

### BACKGROUND

The increasing concentration of carbon dioxide in the atmosphere is recognized as one of the causes of global warming, which is one of the greatest concerns of present days. This increase is largely owed to human actions and particularly to the combustion of carbon-containing fossil fuel, for instance for transportation, household heating, power generation and in energy-intensive industries such as steel, cement and lime manufacturing.

Within the lime-production process, natural limestone (mainly composed of calcium carbonate) is heated to a temperature above 910° C. in order to cause its calcination into quicklime (calcium oxide) and carbon dioxide according to the following reversible reaction:

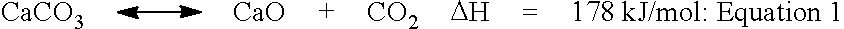

Calcium oxide is considered as one of the most important raw materials and is used in a multitude of applications such as steel manufacturing, construction, agriculture, flue gas and water treatment as well as in glass, paper and food industry. The global annual production is estimated to be above 250 million tons.

As indicated in Equation 1, CO₂ is a co-product of the lime-production process meaning that approximately 760 to 790 kg of CO₂ is unavoidably generated when producing 1 ton of lime. Moreover, the heat required for heating limestone and for conducting the reaction is usually provided by the combustion of a carbonaceous fuel, which results in additional production of CO₂ (ranging between 200 and more than 700 kg per ton of lime depending on the nature of the fuel and efficiency of the kiln).

The use of vertical shaft kiln prevails in the lime industry as they are particularly suitable for the production of lumpy quicklime compared to other types of furnaces, such as rotary kiln, and because they have the advantage of lower specific energy input.

In a single shaft vertical kiln, limestone or dolomitic limestone is fed through the top of the shaft and the produced lime is discharged at its bottom. In the pre-heating zone, the limestone is heated by hot gases flowing upward from the combustion zone. In the combustion zone, heat is produced through the direct firing of a fuel to reach a temperature above 910° C. and consequently causing the decomposition of the limestone into quicklime and CO₂. The lime then enters the cooling zone where it is cooled by air fed from the bottom of the shaft. The produced lime is finally discharged, ground and sieved into the desired particle size. Flue gas leaves the shaft at the top of the pre-heating zone and is fed to a filter system before it is vented to the atmosphere. Specific energy consumption for such single-shaft vertical kilns ranges between 4 and 5 GJ per ton of lime.

Parallel flow regenerative kilns (PFRK) are a variant of vertical shafts that are considered as the best available technology for lime production with design capacity up to 800 tons per day. They consist in several vertical shafts (usually 2 or 3) connected by a cross-over channel. Each shaft operates alternately according to a defined sequence. Initially, fuel is burnt in one of the shaft (“in combustion”) with combustion air flowing downwards (“parallel flow” with the limestone). Hot gases are then transferred to the other shafts (“in regeneration”) through the cross-over channel in order to pre-heat limestone in said other shafts. A reversal between combustion and regeneration shafts occurs typically every 15 minutes.

This operational mode enables optimal recovery of the heat contained in product and hot gases bringing the specific energy consumption down to 3.6 GJ per ton of lime. The combustion of the fuels required to bring this heat results in the production of approximately 200 kg of CO₂ per ton of lime when natural gas is used.

The lime industry is making efforts for reducing its CO₂ emissions by improving energy efficiency (including investment in more efficient kilns), using lower-carbon energy sources (e.g. replacing coal by natural gas or biomass) or supplying lime plants with renewable electricity. The CO₂ related to energy can thus be reduced to some extent. Nevertheless, none of these actions impacts the CO₂ which is inherently produced during decarbonation of limestone.

A route for further reducing emission consists in capturing CO₂ from the lime kiln flue gas for permanent sequestration (typically in underground geological formation) or recycling for further usage (e.g. for the production of synthetic fuels). Those processes are known under the generic term CCUS (Carbon Capture, Utilization and Storage).

Combustion air used in conventional lime kilns contains approximately 79 vol % nitrogen resulting in CO₂ concentration in flue gas not higher than 15-20 vol %. Additional measures are thus required to obtain a CO₂ stream sufficiently concentrated to be compatible with transportation, sequestration and/or utilization.

Several technologies have been investigated for concentrating CO₂ in particular for the power, steel and cement industry.

The reference technology for CO₂ capture is a post-combustion technology based on absorption with aqueous amine solvents. A typical process includes an absorption unit, a regeneration unit and additional accessory equipment. In the absorption unit, CO₂-containing flue gas is contacted with amine solution to produce a CO₂-free gas stream and an amine solution rich in CO₂. The rich solution is then pumped to the regeneration unit where it is heated with steam to produce a concentrated stream of CO₂ and a lean amine that can be recycled to the absorber. The CO₂ stream is then cleaned and liquefied for storage and transportation.

The energy requirements for regenerating an amine solvent (e.g. mono-ethanolamin (MEA)) is substantial (approx. 3.5 GJ per ton of CO₂ for MEA). While recovering waste heat to produce low temperature steam is often possible in other industrial processes, almost no waste heat is available from a PFRK (as a consequence of the high energy efficiency of PFRK). Fuel must thus be burnt for the purpose of generating steam, resulting in additional CO₂ production.

As described above, limestone calcination in a PFRK is an intermittent process in terms of gas flow rate (e.g. absence of flow during reversal) and in term of flue gas composition (CO2 concentration varies during a cycle). In particular, there is a short interruption (called reversal) during two successive burning cycles, in order to feed fresh stone, discharge a batch of lime, and move flaps to alternate burning between the two shafts. During the reversal, the kiln is de-pressurized and the flow of exhaust gases is considerably reduced.

However, amine scrubbers optimally operate with continuous and relatively steady flue gas. In other words, adapting the process to PFR kilns could only be achieved at the expense of a negative impact on the overall efficiency and a complex control of the process.

It is estimated that amine-based CO₂ capture would approximately more than double the production cost of lime or dolime. Those costs are mostly owed to fuel consumption for generating steam, electrical consumption for amine scrubbing and compression, and capital cost for equipment.

Other post-combustion technologies have been proposed for capturing CO₂ from flue gas (e.g. chilled ammonia, adsorption, cryogenic distillation, membranes). All these options show with varying degrees identical drawbacks to those of amines regarding capital cost, energy penalty and adaptability to intermittent processes.

### SUMMARY

The present disclosure aims to provide a solution to overcome at least one drawback of the teaching provided by the prior art, in particular to ensure a continuous exhaust gas flow.

More specifically, the present disclosure aims to provide a process and a device for simultaneously allowing a decarbonation with a high production throughput of a product (e.g. quicklime, dolime) with a high decarbonation grade while producing a CO₂-rich stream that is suitable for sequestration or use.

For the above purpose, the present disclosure is directed to a decarbonation process of carbonated materials, in particular limestone, dolomitic limestone or other carbonated materials, preferably with CO₂ recovery, in a multi-shaft vertical kiln comprising a first, a second, and optionally a third shaft with preheating zones, heating zones and cooling zones and a cross-over channel between each shaft, alternately heating carbonated materials by a combustion of at least one fuel with at least one comburent, preferably said comburent comprising less than 70% N₂ (dry volume), more preferably less than 50% of N₂ (dry volume), in particular said comburent being oxygen-enriched air or substantially pure oxygen, up to a temperature range in which carbon dioxide of the carbonated materials is released, the combustion of the fuel and the decarbonation generating an exhaust gas, the decarbonated materials being cooled in the cooling zones with one or more cooling streams, preferably said streams comprising at least 10% N₂ (dry volume) and/or said streams comprising at least 30% water (dry volume), further comprising extracting the exhaust gas from the multi-shaft vertical kiln and feeding a buffer with said extracted exhaust gas, in particular said buffer being connectable to a CO₂ purification unit which can be fed at any time and/or or continuously with the exhaust gas, said buffer having a constant or variable storage volume.

Preferred embodiments of the process disclose one or more of the following features:
pressurizing the exhaust gas extracted from the multi-shaft vertical kiln before being fed to the buffer by means of one or more compressors, in particular to a level comprised in the range 0.5 to 40 bars above the atmospheric pressure, preferably in the range 1 to 40 bars above the atmospheric pressure, in particular in the range of 0.5 or 1 to 3 bars above the atmospheric pressure, in case the buffer has a constant volume;
pressurizing the exhaust gas extracted from the multi-shaft vertical kiln before being fed to the buffer by means of one or more compressors, in particular to a level comprised in the range of 0.1 to 500 mbars, preferably 0.1 to 100 mbars above the atmospheric pressure, via the displacement of at least one wall section of the buffer in case the buffer has a variable volume;
cooling the exhaust gas extracted from the multi-shaft vertical kiln before entering the buffer, preferably upstream and/or downstream from the one or more compressors, in at least one heat exchanger, preferably cooled by air and/or water;
transferring the exhaust gas from the buffer to the CO₂ purification unit at least during a combustion cycle, a reversal and/or a non-combustion phase in all shafts;
extracting a portion of the exhaust gas from the buffer and recycling said exhaust gas to one of the first, second or third shaft, said shaft being in combustion;
controlling a flow of at least one of the portion of the exhaust gas extracted from the buffer and/or the exhaust gas transferred to the CO₂ purification unit;
recovering energy from the flow of at least one of the portion of exhaust gas extracted from the buffer and/or the exhaust gas transferred to the CO₂ purification unit, expanding during the flow control;
compressing the flow of at least one of the portion of exhaust gas extracted from the buffer and/or the exhaust gas transferred to the CO₂ purification unit during the flow control;
a mixing between the exhaust gas and the one or more cooling streams is minimized by feeding the cooling zone of at least one of the first, the second and/or the third shaft with at least one of the cooling streams, and extracting the at least one of the heated cooling streams at an upper portion of said cooling zone;
the mixing between the exhaust gas and the one or more cooling streams is minimized by operating said kiln in a mode in which between two subsequent alternating heating cycles between the first and the second or the third shaft, the decarbonated materials in at least the first, the second and/or the third shaft are cooled with the one or more cooling streams while a supply of the fuel in each shaft is stopped;
feeding the cooling zone, of at least one of the first, the second and/or the third shaft with the one or more cooling streams and extracting the one or more heated cooling streams at least at an upper portion of said cooling zone and/or from the or at least one of the cross-over channels, reinjecting at least some of the one or more heated cooling streams at a lower portion of the preheating zone of at least one of the first, the second and/or the third shaft while a supply of the fuel in each shaft is stopped;
feeding of the one or more cooling streams in the first, the second or third shaft is stopped, during the two subsequent alternating heating cycles;
the mass flow of the one or more cooling streams supplied, is set up so that it represents at least 90%, preferably 100% of the maximal mass flow of the one or more cooling streams, said maximal mass flow corresponding to the maximal pressure that any of the shafts is capable to sustain, preferably said pressure is comprised in the range 300 to 600 mbars, preferably 450 mbars, over the atmospheric pressure;
draining water condensate formed in the buffer;
filtering the exhaust gas extracted from the multi-shaft vertical kiln before being fed to the buffer by means of one or more filters, in particular a dust filter;
the cooling stream(s) consisting in air, water steam or a mixture thereof;
performing switching from a given combustion cycle in the first shaft to a subsequent combustion cycle in the second shaft in less than 1 minute, in particular in less than 30 seconds;
feeding the carbonated materials into and/or discharging the decarbonated materials from at least one of the first, second and/or third shaft, via a feeding and/or discharging system, respectively, each system comprising a lock chamber delimited by an upstream valve assembly and a downstream valve assembly, said feeding or discharging system being configured to collect the carbonated or decarbonated materials, respectively, while the upstream valve assembly is open and the downstream valve assembly is closed, to store in a substantially gas tight manner the carbonated or decarbonated materials, respectively, while both the upstream and downstream valve assemblies are closed, and to release the carbonated or decarbonated materials, respectively, while the upstream valve assembly is closed and the downstream valve assembly is open;
feeding a storage tank with the exhaust gas extracted from the multi-shaft vertical kiln, said storage tank being connected to a CO₂ purification unit;
boiling liquid CO₂ stored in the storage tank to form recycled exhaust gas and transferring said gas to the multi-shaft vertical kiln;
transferring the CO₂ from the storage tank to the buffer.

The present disclosure is also directed to a multi-shaft vertical kiln comprising a first, a second, and optionally a third shaft with preheating zones, heating zones and cooling zones and a cross-over channel between each shaft, said kiln being arranged for being cooled with one or more cooling streams, said kiln being adapted for carrying out the process according to the present disclosure wherein said kiln comprises an exhaust gas passage collecting system for collecting the exhaust gas extracted from an upper portion of the first and second, optionally the third preheating zone, characterized in that said kiln further comprises a buffer arranged downstream of the exhaust gas passage collecting system for storing the exhaust gas generated in said kiln in a gasified form, wherein the buffer is a constant volume reservoir or the buffer is variable volume reservoir.

Preferred embodiment of the multi-shaft vertical kiln discloses one or more of the following features:
the storage volume of the variable volume reservoir is controlled so that the pressure in the buffer remains substantially constant, more preferably within a range of 0.1 to 500 mbars, preferably 0.1 to 100 mbars above the atmospheric pressure, via the displacement of at least one wall section of the buffer;
at least one dust filter, in particular a dust filter fluidly arranged between the exhaust gas passage collecting system.

### BRIEF DESCRIPTION OF THE DRAWINGS

Aspects of the present disclosure will now be described in more detail with reference to the appended drawings, wherein same reference numerals illustrate same features.

FIGS. 1 to 9 show embodiments according to the present disclosure.

### LIST OF REFERENCE SYMBOLS

MSVK multi-shaft vertical kiln
CPU CO₂ purification unit
10 carbonated materials
14 exhaust gas from combustion chamber 600
20 Fuel
30,31,32 Comburent
40 exhaust gas (from fuel+decarbonation)
50 decarbonated materials
90 cooling streams: at least air and/or CO₂ and/or water steam
100,200 1st, 2nd shafts
110,210 preheating zones
111,211 upper end of preheating zones
120,220 heating zones
130,230 cooling zones
131,231 upper end of cooling zone
132,232 lower end of cooling zone
412 cross over channel
700, 700′ Heat exchanger (e.g. condensation unit)
910 Buffer
920 Tank
1100 Feeding system for the carbonated material feeding
1200 Discharge system for the decarbonated material discharge
1300 Discharge table
1400 Compressor
1500, 1500′ Flow control device (e.g. throttle valve, pump-turbine, turbine, compressor)
1600 Dust filter
1700 Exhaust gas passage collecting system

### DETAILED DESCRIPTION

The present disclosure will now be described more fully hereinafter with reference to the accompanying drawings, in which embodiments of the present disclosure are shown. This invention may however be embodied in many different forms and should not be construed as limited to the embodiments set forth herein; rather, these embodiments are provided for thoroughness and completeness.

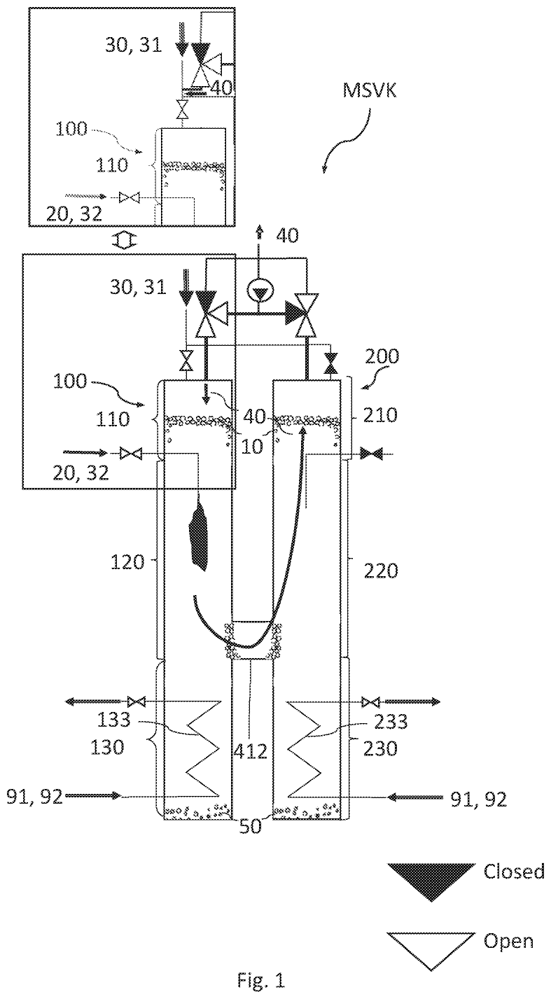

FIG. 1 shows a multi-shaft vertical kiln MSVK according to a first embodiment of the present disclosure. The multi-shaft vertical kiln MSVK in FIG. 1 is based on a traditional parallel-flow regenerative kiln which is a specific case of multi-shaft vertical kiln. The multi-shaft vertical kiln, also designated kiln MSVK comprises a first 100 and a second 200 shaft with preheating zones 110, 210, heating zones 120, 220 and cooling zones 130, 230, as well as a cross-over channel 412 arranged between the first 100 and second 200 shafts. In use, the carbonated materials 10 are introduced at an upper portion 111, 211 of each shaft 100, 200. The carbonated materials 10 slowly move to the bottom. In the preheating zones 110, 210, the carbonated materials 10 are essentially preheated with the alternating regenerative exhaust gas 40. In the combustion zones 210, 220, the carbonated materials 10 are alternately heated by a combustion of fuel 20 with at least one comburent 30, 31, 32, preferably depleted in nitrogen, in particular oxygen-enriched air or substantially pure oxygen, up to a temperature range in which carbon dioxide of the carbonated materials 10 is released. Both the combustion of the fuel 20 with the at least one comburent 30, 31, 32 and the decarbonation generate the exhaust gas 40.

The present disclosure defines that the at least one comburent as an oxidizing agent such as either air, air enriched with oxygen (i.e. oxygen-enriched air) or substantially pure oxygen, alone or in combination with the exhaust gas 40 or substantially pure CO₂. Preferably, the comburent is an oxygen-enriched air or substantially pure oxygen. One or more comburents are foreseen, in particular:
a comburent 30, or
a first 31 and a second comburent 32.

FIG. 1 schematically shows a multi-shaft vertical shaft MSVK with three separate supply passages per shaft:
a first passage is arranged at an upper portion of the multi-shaft vertical kiln (e.g. PFRK) traditionally supplying a (first) comburent 30, 31 (e.g. primary air supply). Even if FIG. 1 shows one first supply passage, the multi-shaft vertical kiln MSVK may comprise more than one first supply passage per shaft 100, 200. The one or more first passage outlet openings are arranged in the corresponding shaft 100, 200. In the present disclosure, the comburent 30 or the first comburent 31 is preferably oxygen-enriched air or substantially pure oxygen.
a second passage (e.g. fuel lance) is traditionally supplying fuel 20 (e.g. natural gas, oil) and optionally the second comburent 32 (e.g. air). Even if FIG. 1 shows only one second supply passage, the multi-shaft vertical kiln comprises one or more second supply passage per shaft 100, 200, generally under the form of fuel/air lances. For instance, a mixture of fuel 20 and the second comburent 32 (e.g. coke with the conveying second comburent such as air) can be supplied through at least a part of the lances. Alternatively, a group of lances supplies the second comburent 32 (e.g. air) while another group of lances supplies the fuel 20 (natural gas or oil). In the present disclosure, the second comburent 32 is preferably oxygen-enriched air or substantially pure oxygen. Furthermore some of the lances can be used to recycle the exhaust gas 40 in the shaft in combustion.
a third passage is shown in FIG. 1. Such a passage is traditionally not present on a multi-shaft vertical kiln MSVK, in particular a parallel flow regenerative kiln PFRK. Said third passage is dedicated to the supply of the recycled exhaust gas 40. The present disclosure is not limited to a single third passage. Indeed, it can be foreseen that one or more third passages are in fluid connection with the corresponding shaft 100, 200.

In an alternative preferred form (shown schematically in a “window” arranged above the MSVK in FIG. 1), a downstream end of the third passage is connected to the first passage. The present disclosure is not limited to a single third passage connected to a single first passage. Indeed, it can be foreseen that one or more downstream ends of the third passage(s) are connected to one or more first passages. The one or more first passages can feed the corresponding shaft 100, 200 with:
a gas mixture comprising the recycled exhaust gas 40 and the first comburent 31 (e.g. oxygen-enriched air or substantially pure oxygen) according to the first preferred alternative, or
the recycled exhaust gas 40 according to the second preferred alternative.

In the above-mentioned first preferred alternative, the fuel 20 (e.g. natural gas or oil, dihydrogen) is supplied via the one or more second passages.

In the above-mentioned second preferred alternative, the one or more second passages supply both the second comburent 32 (e.g. oxygen-enriched air or substantially pure oxygen) and the fuel 20 (e.g. natural gas, oil, coke or dihydrogen). For instance, a group of lances supply the second comburent 32 (e.g. oxygen-enriched air or substantially pure oxygen) while another group supplies the fuel 20 (e.g. natural gas, oil or dihydrogen).

The first, second and third passages can be found in other embodiments of the present disclosure.

In FIG. 1, the decarbonated materials 50 formed after the release of the CO₂ from the carbonated materials 10 are cooled in the cooling zones 130, 230 by an air stream 90.

The exhaust gas recirculated 40 replaces the combustion air. In order to keep the same amount of Oxygen supplied, an Oxygen-enriched comburent can be used. The exhaust gas recirculation allows to generate high CO₂ concentration in the exhaust gas 40 compatible with CO₂ flue gas storage.

In order to minimize the flow intermittency, a buffer 910 is provided downstream from the multi-shaft vertical kiln MSVK. The exhaust gas 40 can be accumulated in the buffer 910 during the combustion phases, in order to have enough quantity of gases to continuously feed the post-combustion system, in particular the CO₂ purification unit CPU during reversal or non-combustion phases. The buffer 910 in FIG. 1 presents a constant volume, knowing that the dimensions in the drawing are not limiting and present for illustrating purposes.

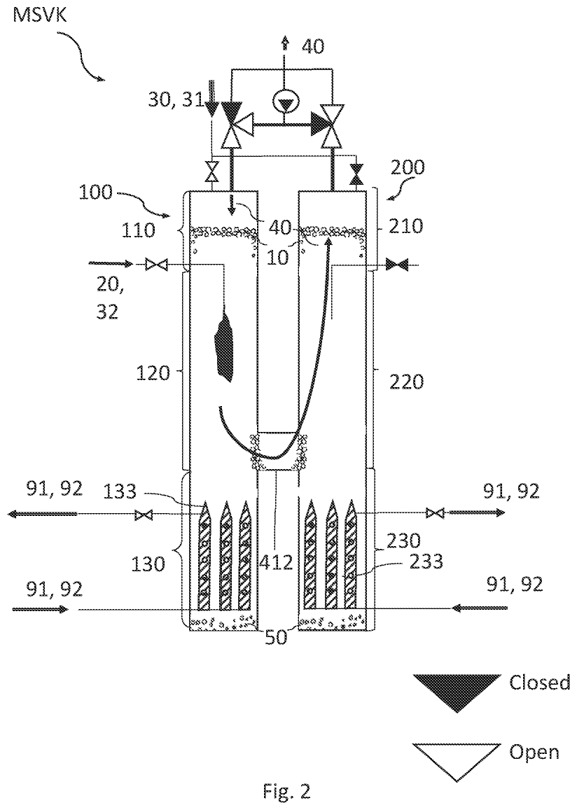

The multi-shaft vertical kiln MSVK according to FIG. 2 differs from that in FIG. 1 in that the heated cooling gas 90 are extracted at an upper portion 131, 231 of the cooling zones 130, 230. This difference minimizes the mixing between the exhaust gas 40 and the air of the cooling stream 90. Owing to these measures, the exhaust gas 40 exits the kiln MVSK with a high content of CO₂ of at least 45% (dry volume), even 60% or more.

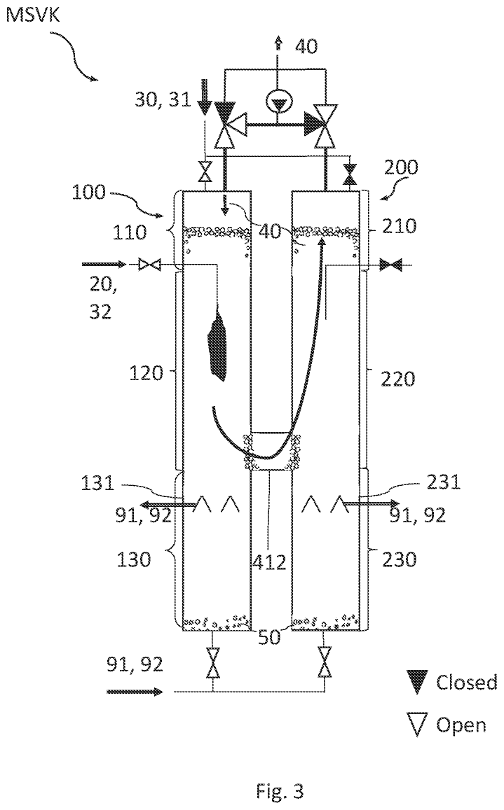

FIG. 3 shows a multi-shaft vertical kiln MSVK according to a third embodiment of the present disclosure. The third embodiment differs from the second embodiment in that a dust filter 1600, a flow control device 1500 and two heat exchanger 700, 700′ are illustrated/

In FIG. 3, the compressor 1400 fluidly arranged between the multi-shat vertical kiln MSVK and the buffer 910 allow to pressurize the exhaust gas 40 and therefore to increase the mass of exhaust gas 40 that can be stored in the buffer 910, whose volume is constant and in some application restricted because of space available. The buffer 910 ensures that the CO₂ purification unit CPU can be fed at any time with the exhaust gas 40. The CO₂ purification unit CPU is configured to remove at least one of the following elements: acid gases, O2, Ar, CO, H2O, NOx, sulfur compounds, heavy metals, in particular Hg, Cd, and/or organic compounds, in particular CH₄, benzene, hydrocarbons. Preferably, the CO₂ purification unit CPU is adapted to adjust the composition of the exhaust gas 40 to the specification required by a carbon capture and utilization or carbon capture and storage application, preferably with a CO2 content above 80% (dry volume) and more preferably above 95% (dry volume).

The exhaust gas 40 extracted from the buffer 910 is preferably cooled in a first heat exchanger 700 arranged upstream from the compressor 1400 so that the power required to compress the exhaust gas 40 is reduced compared to a situation with no cooling.

The exhaust gas 40 extracted from the compressor 1400 is preferably cooled in a second heat exchanger 700′ arranged downstream from the compressor 1400 and upstream from the buffer 910 so as to improve the volumetric efficiency and therefore increase the amount of exhaust gas 40 stored in the buffer 910.

Advantageously, flaps (not shown) can be provided upstream from an inlet of the buffer 910 and downstream for one or more outlets of the buffer 910 so as to restrain depressurization in particular when the compressor 1400 is not pumping.

The buffer 910 can be provided with a drain system to remove water condensates, as the exhaust gas 40 is cooled.

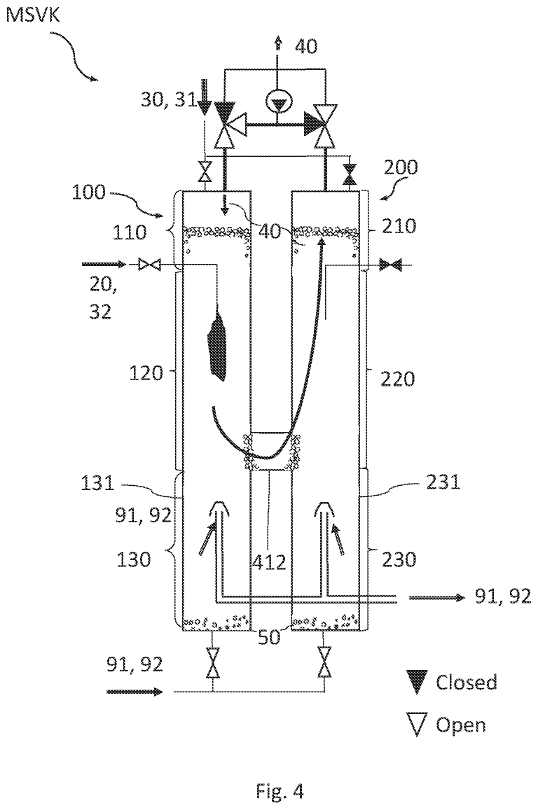

The exhaust gas 40 stored in the buffer 910 can be recirculated to the multi-shaft vertical kiln MSVK in the fourth embodiment as shown in FIG. 4, as a complement to the recirculation of exhaust gas extracted directly from the shaft in regeneration as illustrated in the previous embodiment. Alternatively, the exhaust gas 40 stored in the buffer 910 can be recirculated to the multi-shaft vertical kiln MSVK without recirculation of exhaust gas extracted directly from the shaft in regeneration as illustrated in the previous embodiment. This alternative is not illustrated.

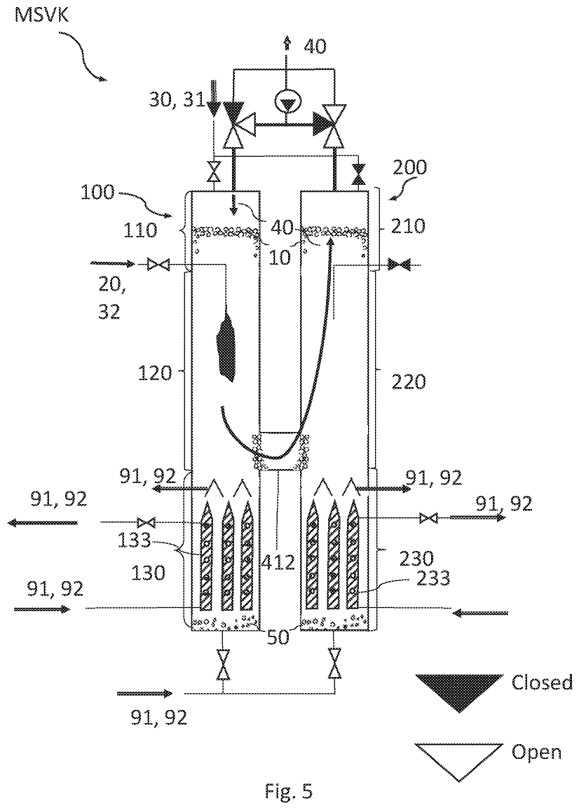

FIG. 4 shows two flow control devices 1500, 1500′. A flow control device 1500 is positioned between the buffer 910 and the CO₂ purification unit CPU and another 1500′ positioned between the buffer 910 and the multi-shaft vertical kiln ensuring the exhaust gas recirculation to the shaft in combustion. The two flow control devices 1500, 1500′ shown in FIG. 5 comprise one element selected in the list comprising a throttle valve, a pump-turbine, a turbine, a compressor or any combination thereof. Such a compressor, pump-turbine or turbine can be a fan with/without a fixed distributor/diffusor alone or coupled to a variable distributor and/or diffusor. In a preferred embodiment, the pump-turbine(s) and/or turbine(s) selected are mechanically connected to at least one electric motor-generator(s) and/or electric generator(s) allowing electrical power recovering using pressure difference between the buffer 910 and the multi-shaft vertical kiln, thereby producing regenerative current.

The fifth embodiment according to FIG. 5 shows that the exhaust gas 40 stored in the buffer 910 can also be recirculated to some of the lances of the shaft that is in combustion as a complement of supplying the recirculated exhaust gas via the upper portion 111, 211 of the preheating zone 110, 210 as shown in any of FIG. 1 to 4.

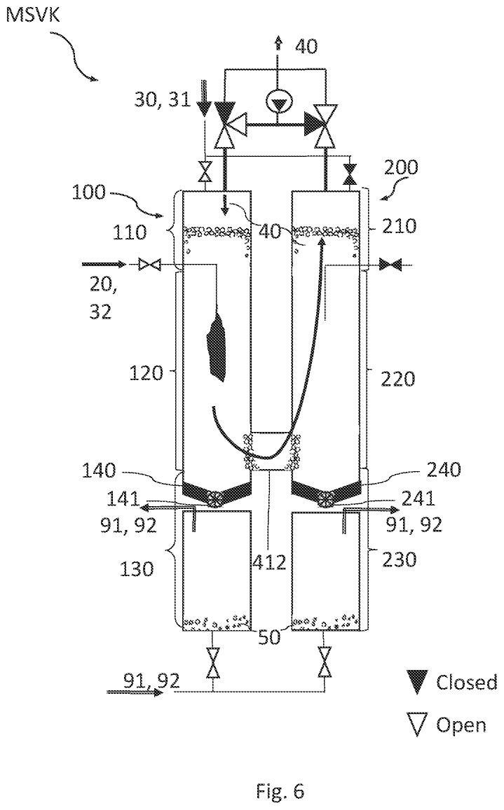

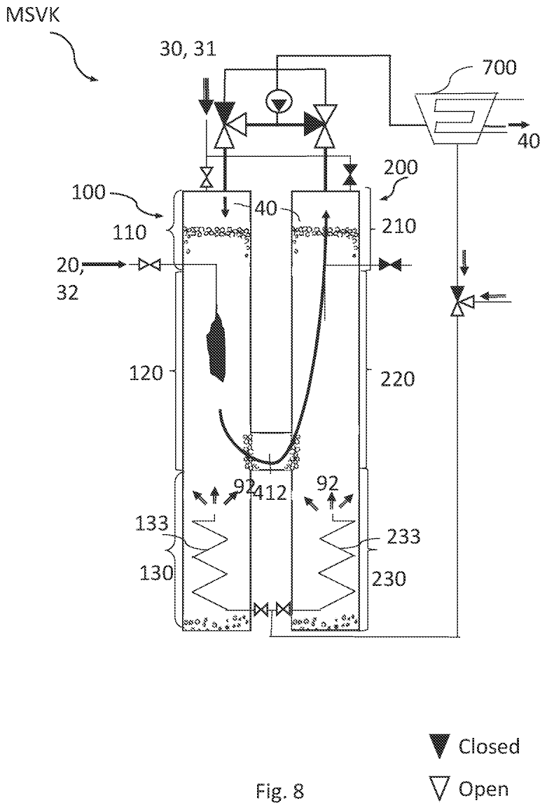

An typical amount of exhaust gas 40 stored in the buffer 910 necessary for a continuous supply of the CO₂ purification unit CPU can be reduced if the multi-shaft vertical kiln MSVK is operated in such a manner that the occurrences and/or the duration phases, in which no or a limited amount of exhaust gas 40 is extracted, are reduced. This can be performed using one or more of the following measures:
ensuring short reversals and/or short non-combustion phases,
providing double flaps to load stone and discharge the lime during combustion or cooling cycle (without kiln depressurization), as shown in FIG. 6;
preventing kiln depressurizing during reversal;
boosting of cooling air flow when cooling is performed without combustion, as shown in FIG. 8;
increasing allowable pressure in buffer 910; and/or
shortening kiln cycle duration.

FIG. 6 shows a sixth embodiment according to the present disclosure, which differs from the embodiment in FIG. 2 in that the MSVK comprises feeding and discharging systems 1100, 1200, respectively, for the feeding of carbonated materials 10 and the discharge of the decarbonated material 50, in order to minimize the idle time between cycles (reversal time) and to reduce or even eliminate the need for exhaust gas buffering before the CO2 purification unit (CPU). The feeding and discharge systems 1100, 1200, with for instance an upstream gas-tight flap valve and a downstream gas-tight flap valve can be integrated to anyone of the previously mentioned embodiment. A lock chamber of the feeding 1100 or discharging system 1200 is delimited by the upstream gas-tight flap valve and a downstream gas-tight flap valve. The lock chamber presents a working volume adapted to store the material batches to be fed into or discharged from the corresponding shaft 100, 200. By gas tight, is meant a valve assembly that substantially limits the gas exchanges to as to ensure an efficient usage of the MSVK and to minimize combustion gas leakage into the atmosphere. The MSVK in FIG. 6 can ensure short reversals, for instance less than 1 minute, in particular in less than 30 seconds.

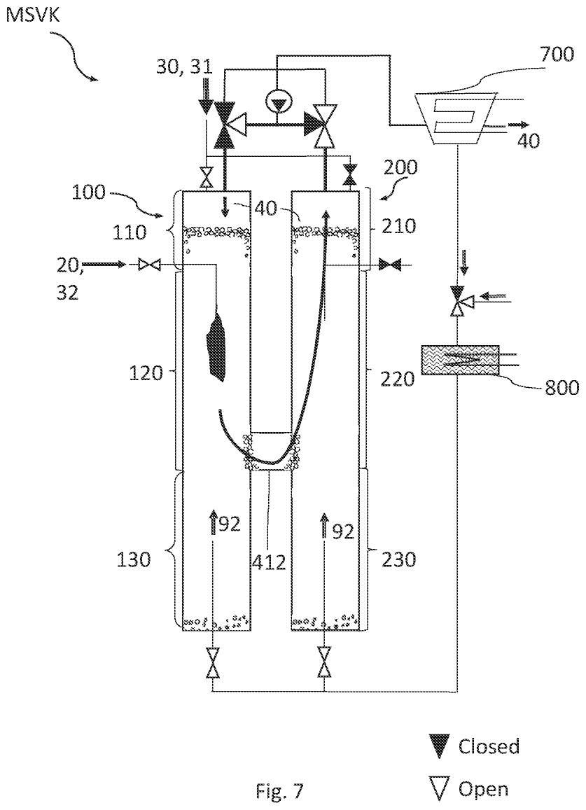

A multi-shaft vertical kiln MSVK according to the seventh embodiment according to FIG. 7 differs from the fourth embodiment in that a tank 920 is positioned downstream for the CO₂ purification unit CPU. The tank 920 is be provided to store a CO₂ gas purified by the CO₂ purification unit CPU. In case of too low pressure in the buffer 910 (not enough pressure to insure the exhaust gas recirculation), CO₂ gases could be supplied by the storage tank 920 to the multi-shaft vertical kiln MSVK as shown in FIG. 7. Furthermore, the buffer 910 can be directly supplied with CO₂ stored in the storage tank 920. With this measure, any pressure loss in the buffer 910 can be rapidly compensated.

FIG. 8 shows a eight embodiment of a multi-shaft vertical kiln MSVK. Contrary to any of the previous embodiments, this embodiment differs from a traditional parallel-flow regenerative kiln PFRK in that the control of the kiln leads to a CO₂-enriched exhaust gas besides structural modifications. For instance, the control of the opening or closing of the valves (e.g. louvers) as well as the activation of the blowers are set up so that the contacts of combustion flows and cooling flows are minimized. This embodiment is characterized in that between two subsequent, alternating heating cycles between the first 100 and the second 200 shafts, the decarbonated materials 50 in at least the first 100 and/or the second 200 shaft are cooled with a cooling stream 90, in particular air, while a supply of the fuel 20 and optionally the at least one comburent 30, 31 in each shaft 100, 200 is stopped. This operation mode is also named “intermittent flush”. Generally, this embodiment requires few modifications to an existing parallel-flow regenerative PFRK to operate. The modifications may comprise for instance the provision of an oxygen-enriched comburent and new software. Starting from a MSVK, this embodiment is therefore practical to implement. Nevertheless, this embodiment may require further hardware modifications as show in FIG. 8 such as the provision of collecting rings arranged at the lower portion of the preheating zones 112, 212 and passages connecting said rings to the cross over channel 412. This way of operating the MSVK in which the cooling steams 90 and the exhaust gas stream are separated in the “time” allows to generate exhaust gas with a high CO₂ content, as the previous embodiments relying on “physical” separation between cooling steams 90 and the exhaust gas stream do.

In this embodiment, the control of the MVSK can comprise the following sequential cycles:
Cycle 1 comprises feeding the first shaft 100 with fuel 20, at least one comburent 30, 31, 32 (e.g. air, air enriched with oxygen or substantially pure oxygen) and the recycled exhaust gas 40 from the second shaft 200, while transferring the generated exhaust gas 40 to the second shaft 200 via the cross-over channel 412: H1R2 (heating shaft 1, regeneration shaft 2).
Cycle 2 comprises feeding the second 200 shaft with a cooling stream 90 at the lower portion 232 of its cooling zone while extracting the heated cooling stream 90 (e.g. air) in the cross over channel 412 and reinjecting the heated cooling stream 90 in the lower portion 212 of the preheating zone of the second shaft 200, by means of a collecting ring: C1-2 (cooling shaft 2).
Cycle 3 comprises feeding the second shaft 200 with the fuel 20, the at least one comburent 30, 31, 32 (e.g. air, air enriched with O₂ (i.e. oxygen-enriched air) or substantially pure oxygen) and the recycled exhaust gas 40 from the first shaft 100, while transferring the generated exhaust gas 40 to the first shaft 200 via the cross-over channel 412: R1H2 (heating shaft 1, regeneration shaft 2)
Cycle 4 comprises feeding at least the first 100 shaft with the cooling stream 90 at the lower portion 132 of its cooling zone while extracting the heated cooling stream 90 in the cross over channel 412 and reinjecting the heated cooling stream 90 in the lower portion 212 of the preheating zone of the first shaft 100, by means of a collecting ring: C1-2 (cooling shaft 1).

Even if FIG. 8 shows that only one shaft is flushed per cooling cycle, in an alternative, both shaft can be flushed simultaneously (C1-2) to reduce the cooling phase duration.

The above mentioned sequence can be described as H1 R2, C2, R1H2, C1, . . . , H1 R2, C2, R1H2, C1. The eight embodiment is not limited to this sequence and can follow various patterns that can be adjusted depending on the circumstances such as H1 R2, C1-2, R1H2, C2, C1-2, C2, R1H1, C1, R1H2, . . . .

The embodiment in FIG. 8 shows that the intermittency is not limited to the reversal phase as the cooling phase is not concomitant with the combustion phase. As, there is no exhaust gas 40 generated by combustion during the cooling phases, the buffer 910 ensures a continuous supply of exhaust gas 40 even if no combustion takes place in the multi-shaft vertical kiln MSVK.

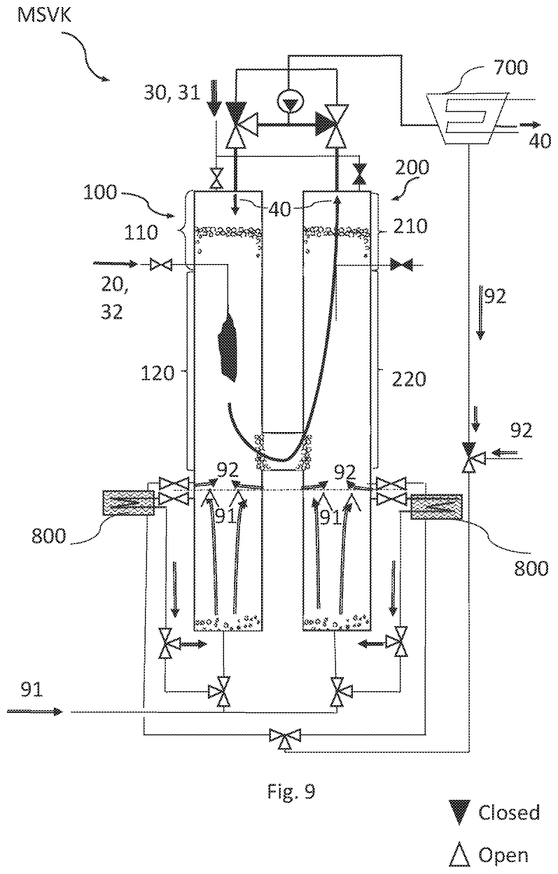

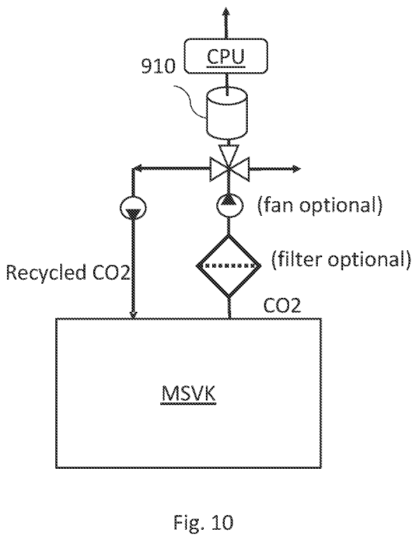

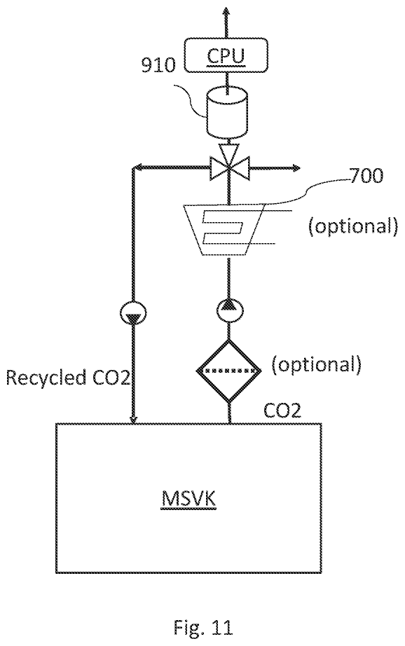

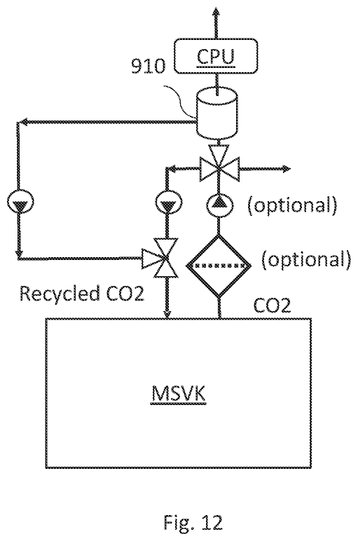

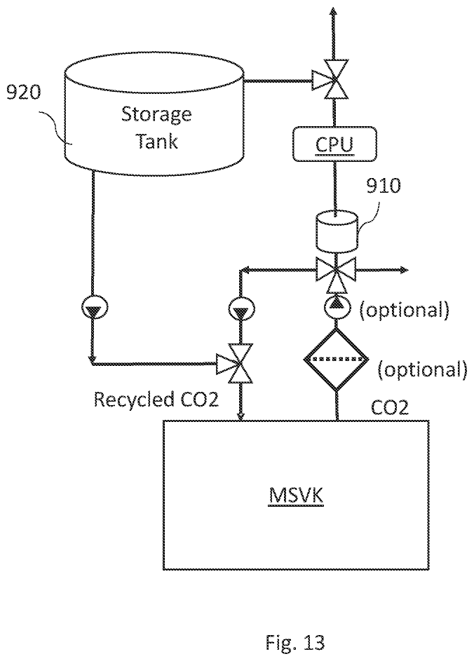

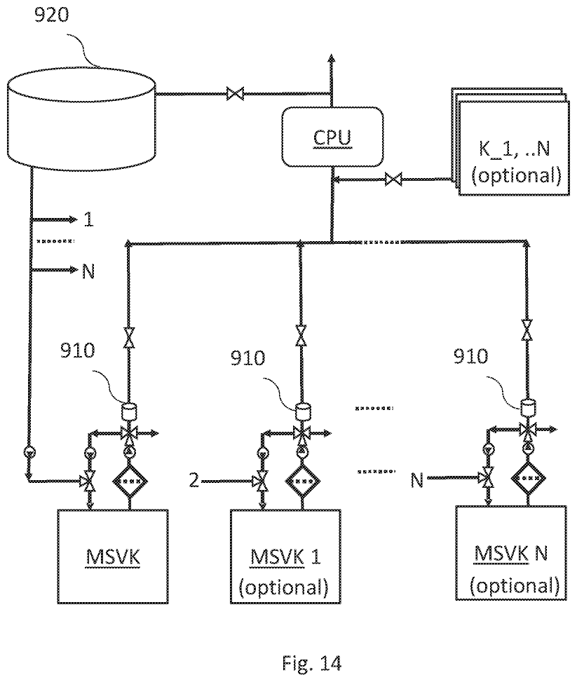

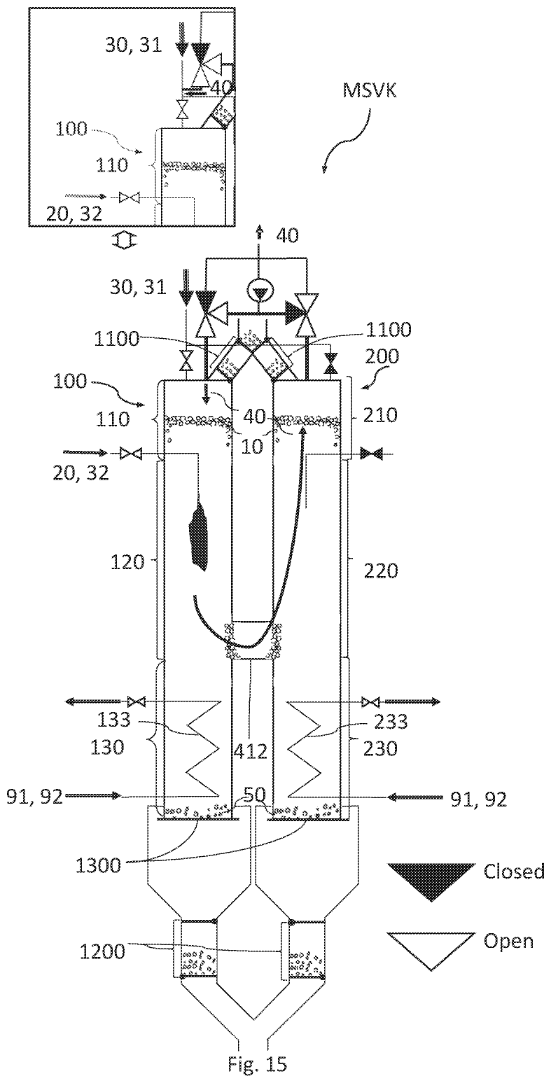

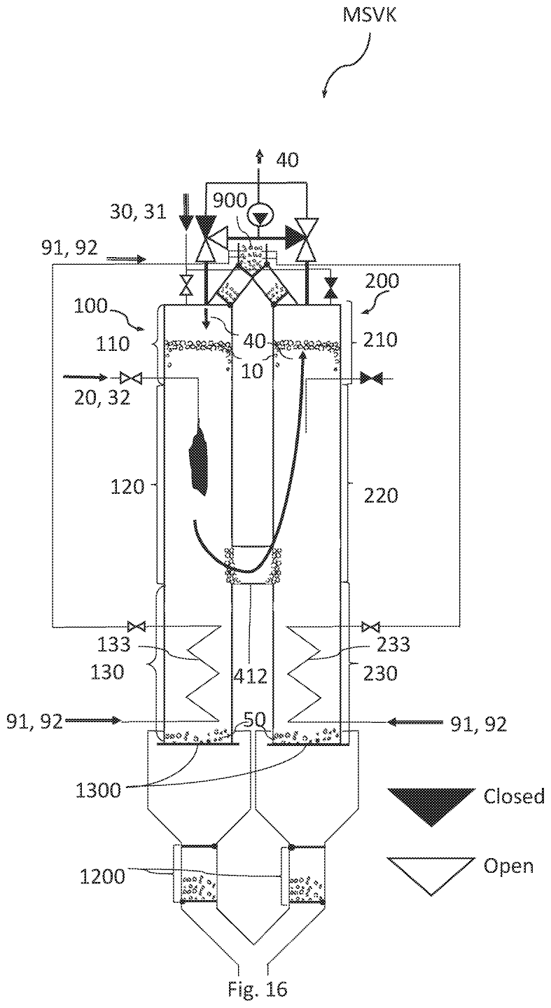

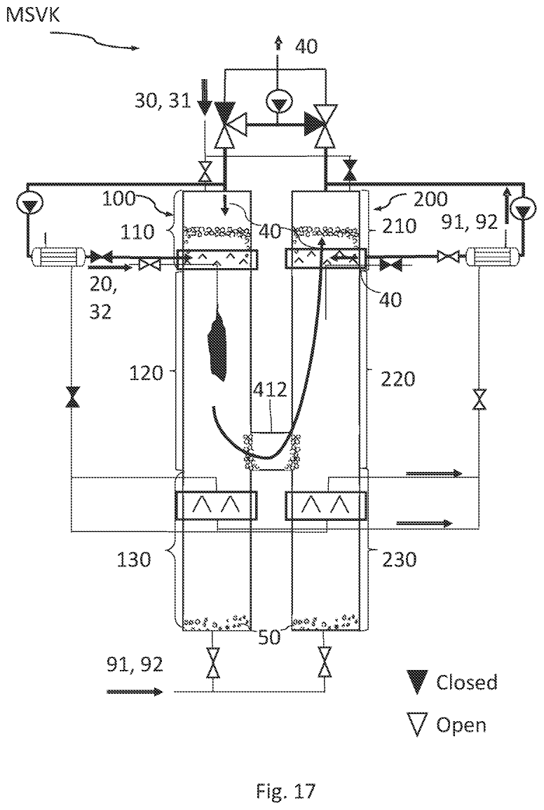

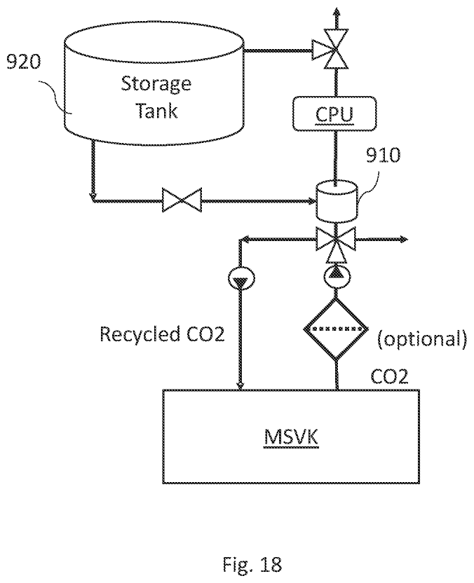

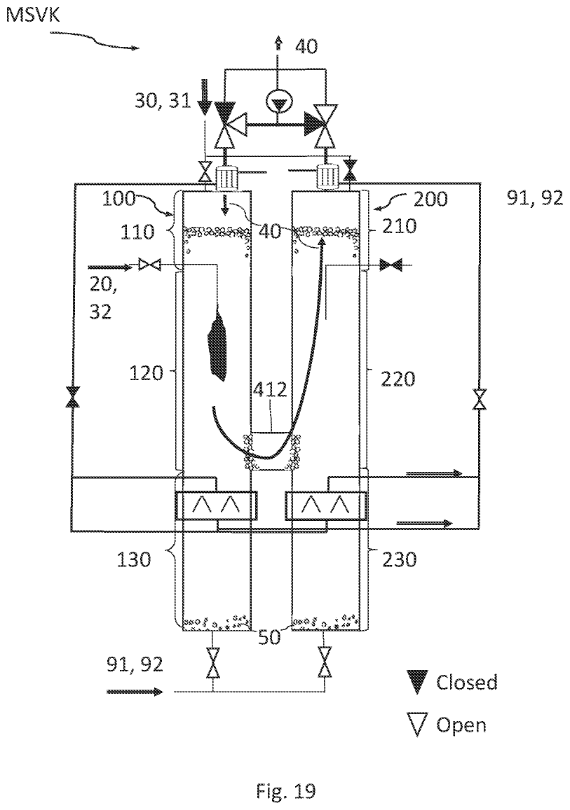

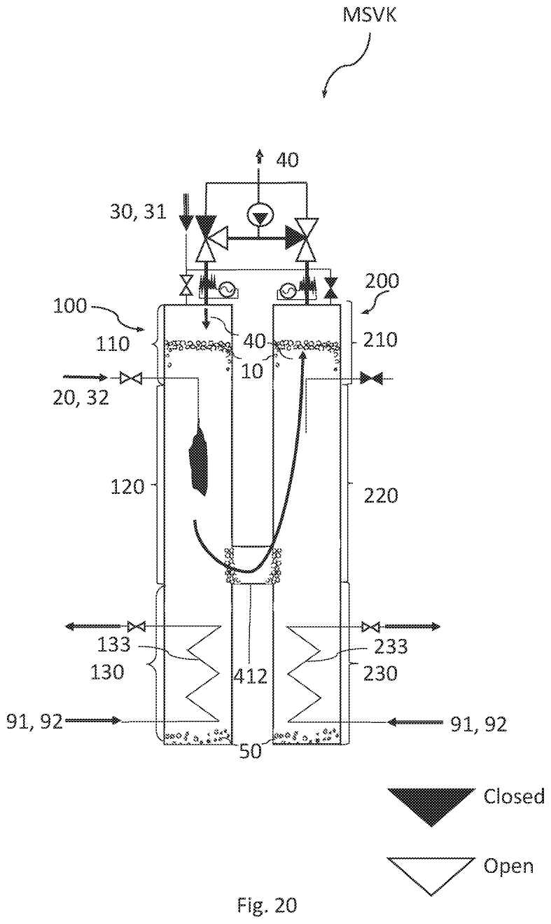

FIG. 9 shows an ninth embodiment that differs from the third embodiment in that the multi-shaft vertical kiln MSVK comprises a variable volume reservoir such as a bellow arranged inside a receptacle. The pressure exerted on the bellow is controlled, in particular in a range of 0.1 to 500 mbars, preferably 0.1 to 100 mbars above atmospheric pressure so that the variable volume of the bellow expands or contracts depending on the amount of exhaust gas 40 stored therein. A variable volume reservoir suitable for the present disclosure is not limited to a bellow and can comprise for instance a bladder reservoir or equivalent. The cooling of the exhaust gas 40 allows to have thermal conditions compatible with elastomeric elastic membrane used for certain type of variable volume reservoir (e.g. bladder or below reservoir).

The control of the pressure within the gas storing variable chamber can be passively controlled to the extent that the variable volume is a function of the elastic properties of a gas containing element comprised in the list: a membrane, bladder, bellow, one or more resilient means acting on at least one slidable wall of the chambre, or any combination thereof. Equally, the pressure exerted on the gas containing element also influences said element. But, in a passive control, the pressure, such as atmospheric pressure would not be controlled.

Alternatively, the control of the pressure within the gas storing variable chamber can be actively controlled to the extent that at least one actuator influences the displacement of at least a portion of the gas containing element. Equally the pressure exerted on the gas containing element can be controlled as illustrated in FIG. 9.

Complementary or alternatively to any of the previous embodiment, at least one air separation unit ASU is provided in the proximity of the MSVK and optionally one or more additional kilns. The one or more ASU generate an Oxygen-enriched composition that can be fed in the MSVK and optionally in at least one another kiln as comburent 30, 31, 32. An ASU also produces a Nitrogen-enriched composition that can be released in the atmosphere.

Typically, an ASU produces both an Oxygen-enriched composition comprising at least 70% (dry volume) O₂, preferably at least 90% (dry volume), in particular at least 95% and a Nitrogen-enriched composition comprising at least 80% (dry volume) N₂ preferably at least 90% (dry volume), particular at least 95% (dry volume) and less than 19% (dry volume) O₂, preferably less than 15% (dry volume), in particular less than 10% (dry volume).

Preferably, the comburent 30, 31, 32 fed in the MSVK comprises at least 40% (dry volume), preferably at least 70% (dry volume), in particular at least 90% (dry volume), in particular at least 95% (dry volume) of the Oxygen-enriched composition.

The Nitrogen-enriched composition can be advantageously used to cool the MSVK during the heating cycles. Indeed, on one hand, the supply of comburent 30, 31, 32 fed in the pre-heating 110, 210 and combustions 120, 220 zones is adjusted so that a near stoichiometric combustion is achieved in the MSVK in the combustion zones 120, 220 of the MSVK, on the other, the cooling stream 90 comprising at least 80% (dry volume), preferably at least 90% (dry volume), in particular at least 95% (dry volume) of said Nitrogen-enriched composition is expected to dilute the exhaust gas 40. The amount of residual Oxygen present in the nitrogen-enriched composition is however sufficiently low to the extent that it dilutes the exhaust gas 40 without changing significantly the overall stoichiometric balance. A reduction in the amount of Oxygen introduced via the cooling stream 90 will improve the purification efficiency of the CPU.

Advantageously, the at least one fuel 20 used in a kiln MSVK according to the present disclosure, in particular in any of the previous embodiments is either carbon-containing fuel or dihydrogen-containing fuel or a mixture of them. A typical fuel can be either wood, coal, peat, dung, coke, charcoal, petroleum, diesel, gasoline, kerosene, LPG, coal tar, naphtha, ethanol, natural gas, hydrogen, propane, methane, coal gas, water gas, blast furnace gas, coke oven gas, CNG or any combination of them. Furthermore, the kiln MVSK can use, for instance, two sources of fuel with different compositions.

Advantageously, the decarbonated materials 50 produced in a kiln MSVK according to the present disclosure, in particular in any of the previous embodiments have a residual CO₂<5%, preferably <2%, resulting from the rapid cooling of the decarbonated materials 50.

Preferably, measures are undertaken to recover heat from the one or more cooling streams 90, and/or the recirculated exhaust gas 40.

Advantageously, the combustion of at least one fuel 20 with the at least one comburent 30 is under an oxygen-to-fuel equivalence ratio greater or equal to 0.9.

The comburent comprises less than 70% N₂ (dry volume), in particular less than 50% of N₂ (dry volume), in particular oxygen-enriched air. In particular, the comburent used in the present disclosure, is a mixture of air with a substantially pure oxygen, the comburent comprising at least 50% O2 (dry volume), preferably more that 80% O₂ (dry volume).

The meaning of “substantially pure oxygen” in the present disclosure is an oxygen gas comprising at least 90% (dry volume) dioxygen (i.e. O₂), preferably at least 95% (dry volume) dioxygen (i.e. O₂).

The meaning of “multi vertical-shaft kiln” in the present disclosure is a kiln comprising at least two shafts 100, 200. The shafts 100, 200 are not coaxial and are disposed side by side to the extent that any shaft of a group consisting of the first, second and optimally the third shaft 100, 200 is not encircled by the other or another shaft 100, 200 of said group. In other words, the cross-over channel(s) 412 are arranged outside the shafts 100, 200. This definition excludes an annular-shaft kiln being interpreted as a multi vertical-shaft kiln. A parallel-flow regenerative kiln is a specific form of a multi vertical-shaft kiln in the present definition. The multi vertical-shaft kiln of the first to the fourteenth embodiment falls in the definition of a parallel-flow regenerative kiln (in German: “Gleich Gegenstrom Regernativ Ofen”). According to the present disclosure, the term “vertical” in “multi vertical-shaft kiln” does not necessarily require that the longitudinal axes of the shafts 100, 200 have an exact vertical orientation. Rather, an exact vertical directional component of the alignment should be sufficient, with regard to an advantageous gravity-related transport of the material in the shafts, an angle between the actual alignment and the exact vertical alignment amounts to at most 30°, preferably at most 15° and particularly preferably of 0° (exactly vertical alignment).

Each shaft 100, 200 of the multi-shaft vertical kiln comprises a preheating zone 110, 210, a heating zone 120, 220 and a cooling zone 130, 230. A cross-over channel 412 is disposed between each shaft 100, 200. According to the present disclosure, the junction between the heating zones 120, 220 and the cooling zones 130, 230 is substantially aligned with the lower end of the cross-over channel(s) 412.

The present disclosure presents a multi-shaft vertical kiln with two or three shafts. The present teaching applies to multi-shaft vertical kiln with four and more shafts.

1-22. (canceled)

23. A decarbonation process for carbonated materials (10) with CO₂ recovery, in a multi-shaft vertical kiln (MSVK) comprising a first (100), a second (200), and optionally a third (300) shaft with preheating zones (110, 210, 310), heating zones (120, 220, 320) and cooling zones (130, 230, 330), and a cross-over (412, 423, 431) channel between each shaft (100, 200, 300), the process comprising:
alternately heating carbonated materials (10) by a combustion of at least one fuel (20) with at least one comburent (30, 31, 32) comprising less than 70% N₂ (dry volume), said comburent being oxygen-enriched air or substantially pure oxygen, up to a temperature range in which carbon dioxide of the carbonated materials (10) is released,
generating an exhaust gas (40) from the combustion of the fuel (20) and the decarbonation, and
cooling the decarbonated materials (50) in the cooling zones (130, 230, 330) with one or more cooling streams (91, 92),
said process further comprising cooling the decarbonated materials (50) with the one or more cooling streams (92) comprising a water steam stream, said stream being fed in the cooling zone (130, 230, 330) of at least the first (100), the second (200) and/or the third (300) shaft.

24. The process of claim 23, further comprising:
providing water for the water steam stream (92) via:
cooling the exhaust gas (40) extracted from at least the first (100), the second (200) and/or the third (300) shaft in a separate condensation (700) unit; and/or
an external water source;
boiling the water in:
at least one boiler (800); and/or
at least one of the heat exchangers (133, 233, 333),
into the water steam stream (92) that is fed in at least the first (100), second (200) and/or third (300) shaft.

25. The process of claim 23, wherein the one or more cooling streams (91, 92) further comprise an additional cooling stream (91) comprising at least 95% of air (dry volume);
said process further comprising feeding the additional cooling stream (91) in the cooling zone (130, 230, 330) of at least the first (100), the second (200) and/or the third (300) shaft, in particular at the lower portion (132, 232, 332) thereof, and extracting the heated additional cooling stream (91) from said shafts (100, 200, 300), wherein an inlet opening in the first, the second or the third shaft cooling zone (130, 230, 330), through which the water steam stream (92) is fed, is positioned above an outlet opening in the same shaft (100, 200, 300), through which the heated additional cooling (91) is extracted.

26. The process of claim 25, further comprising: providing at least one hopper (900) for conditioning the carbonated materials (10) before they are fed to at least one of the first (100) and/or the second shaft (200), and supplying the at least one hopper (900) with the one or more of the heated cooling streams (91) extracted from one or more of said outlet openings

27. The process of claim 23, further comprising feeding the carbonated materials (10) into and/or discharging the decarbonated materials (50) from at least one of the first, second and/or third shaft (100, 200, 300), via a feeding and/or discharging system (1100, 1200), respectively, each system (1100, 200) comprising a lock chamber delimited by an upstream valve assembly and a downstream valve assembly, said feeding or discharging system (1100, 1200) being configured to collect the carbonated (10) or decarbonated materials (50), respectively, while the upstream valve assembly is open and the downstream valve assembly is closed, to store in a substantially gas tight manner the carbonated (10) or decarbonated materials (50), respectively, while both the upstream and downstream valve assemblies are closed, and to release the carbonated (10) or decarbonated materials (50), respectively, while the upstream valve assembly is closed and the downstream valve assembly is open.

28. The process of claim 23, further comprising providing one or more additional kilns (MSVK_1, MSVK_2, MSVK_N, K_1, K_N) to the multi-shaft vertical kiln (MSVK) forming a plurality of kilns generating an aggregated exhaust gas stream, so as to minimize flow variation of the aggregated exhaust gas stream entering a CO₂ purification unit (CPU), coordinating the plurality of kilns by selecting at least one cycle phasing and duration of said kilns.

29. The process of claim 23, wherein the fuel (20) used is carbon-containing fuel, dihydrogen-containing fuel, or a mixture of dihydrogen-containing fuel and dihydrogen-containing fuel.

30. The process of claim 23, further comprising recirculating the exhaust gas (40) alternately exiting the second (200) or the first (100) shaft, to the first (100) or second (200) shaft, respectively, such that the recirculated exhaust gas (40) is mixed with the at least one comburent (30, 31, 32) before being fed to the corresponding shaft (100, 200).

31. The process of claim 23, wherein the at least one comburent (30, 31, 32) supplied in the preheating zones (110, 210, 310) and/or heating zones (120, 220, 320) during a given heating cycle in the first shaft (100) and a subsequent heating cycle in the second (200) or third shaft (200) comprises at least 40% (dry volume).

32. A decarbonation process for carbonated materials (10) with CO₂ recovery, in a multi-shaft vertical kiln (MSVK) comprising a first (100), a second (200), and optionally a third (300) shaft with preheating zones (110, 210, 310), heating zones (120, 220, 320) and cooling zones (130, 230, 330), and a cross-over (412, 423, 431) channel between each shaft (100, 200, 300), the process comprising:
alternately heating carbonated materials (10) by a combustion of at least one fuel (20) with at least one comburent (30, 31, 32) comprising less than 70% N₂ (dry volume), said comburent being oxygen-enriched air or substantially pure oxygen, up to a temperature range in which carbon dioxide of the carbonated materials (10) is released,
generating an exhaust gas (40) from the combustion of the fuel (20) and the decarbonation, and
cooling the decarbonated materials (50) in the cooling zones (130, 230, 330) with one or more cooling streams (91, 92),
said process further comprising:
providing a heat exchanger (133, 233, 333) in the cooling zone (130, 230, 330) of at least the first, the second and/or the third shaft (100, 200, 300) for the cooling of the decarbonated materials (50), said heat exchangers (133, 233, 333) being fed by the one or more cooling streams (91, 92).

33. The process of claim 32, further comprising feeding the cooling zone (130, 230, 330) of at least the first, the second and/or the third shaft with at least the additional cooling stream (91), and extracting the at least one of the heated cooling streams (91, 92) at an upper portion (131, 231, 331) of said cooling zone (130, 230, 330).

34. The process of claim 32, further comprising: providing at least one hopper (900) for conditioning the carbonated materials (10) before they are fed to at least one of the first (100) and/or the second shaft (200), and supplying the at least one hopper (900) with the one or more of the heated cooling streams (91) extracted from the upper portion (111, 211) and/or the heat exchanger (133, 233) of the cooling zone (130, 230) of the first and/or second shafts (100, 200)

35. The process of claim 32, further comprising feeding the carbonated materials (10) into and/or discharging the decarbonated materials (50) from at least one of the first, second and/or third shaft (100, 200, 300), via a feeding and/or discharging system (1100, 1200), respectively, each system (1100, 200) comprising a lock chamber delimited by an upstream valve assembly and a downstream valve assembly, said feeding or discharging system (1100, 1200) being configured to collect the carbonated (10) or decarbonated materials (50), respectively, while the upstream valve assembly is open and the downstream valve assembly is closed, to store in a substantially gas tight manner the carbonated (10) or decarbonated materials (50), respectively, while both the upstream and downstream valve assemblies are closed, and to release the carbonated (10) or decarbonated materials (50), respectively, while the upstream valve assembly is closed and the downstream valve assembly is open.

36. The process of claim 32, further comprising providing one or more additional kilns (MSVK_1, MSVK_2, MSVK_N, K_1, K_N) to the multi-shaft vertical kiln (MSVK) forming a plurality of kilns generating an aggregated exhaust gas stream, so as to minimize flow variation of the aggregated exhaust gas stream entering a CO₂ purification unit (CPU), coordinating the plurality of kilns by selecting at least one cycle phasing and duration of said kilns.

37. The process of claim 32, further comprising recirculating the exhaust gas (40) alternately exiting the second (200) or the first (100) shaft, to the first (100) or second (200) shaft, respectively, such that the recirculated exhaust gas (40) is mixed with the at least one comburent (30, 31, 32) before being fed to the corresponding shaft (100, 200).

38. The process of claim 32, wherein the at least one comburent (30, 31, 32) supplied in the preheating zones (110, 210, 310) and/or heating zones (120, 220, 320) during a given heating cycle in the first shaft (100) and a subsequent heating cycle in the second (200) or third shaft (200) comprises at least 40% (dry volume).

39. The process of claim 32, further comprising feeding the Oxygen-enriched composition alone or mixed with the recycled exhaust gas, in the preheating zones (110, 210, 310) and/or heating zones (120, 220, 320).

40. The process of claim 32, further comprising mixing the Oxygen-enriched composition with another comburent such as air and optionally the recycled exhaust gas before feeding said mixture in the preheating zones (110, 210, 310) and/or heating zones (120, 220, 30).

41. A decarbonation process for carbonated materials (10) with CO₂ recovery, in a multi-shaft vertical kiln (MSVK) comprising a first (100), a second (200), and optionally a third (300) shaft with preheating zones (110, 210, 310), heating zones (120, 220, 320) and cooling zones (130, 230, 330), and a cross-over (412, 423, 431) channel between each shaft (100, 200, 300), the process comprising:
alternately heating carbonated materials (10) by a combustion of at least one fuel (20) with at least one comburent (30, 31, 32) comprising less than 70% N₂ (dry volume), said comburent being oxygen-enriched air or substantially pure oxygen, up to a temperature range in which carbon dioxide of the carbonated materials (10) is released,
generating an exhaust gas (40) from the combustion of the fuel (20) and the decarbonation, and
cooling the decarbonated materials (50) in the cooling zones (130, 230, 330) with one or more cooling streams (91, 92),
said process further comprising at least one of the following steps:
(a) cooling the decarbonated materials (50) with the one or more cooling streams (92) comprising a water steam stream, said stream being fed in the cooling zone (130, 230, 330) of at least the first (100), the second (200) and/or the third (300) shaft;
(b) providing a heat exchanger (133, 233, 333) in the cooling zone (130, 230, 330) of at least the first, the second and/or the third shaft (100, 200, 300) for the cooling of the decarbonated materials (50), said heat exchangers (133, 233, 333) being fed by the one or more cooling streams (91, 92);
(c) separating each shaft (100, 200, 300) with a selective separation means (141, 241, 341) arranged in an upper portion of the corresponding cooling zone (130, 230, 330), said selective separation means (141, 241, 341) dividing the inner space of the corresponding shaft (100, 200, 300) into an upper space and a lower space, said selective separation means (141, 241, 341) being arranged so as to allow the transfer of the decarbonated materials (50) between the upper and the lower spaces while substantially preventing the passage of the one or more cooling streams (91, 92) and/or the exhaust gas (40);
(d) recirculating at least a portion of the exhaust gas (40) alternately exiting the second (200) or the first shaft (100), injecting the recirculated exhaust gas (40) in a lower portion of the preheating zone (112, 212) of the second shaft (200) or the first shaft (100), respectively, in particular by means of a collecting ring encircling said shaft (100, 200), feeding the cooling zone (130, 230) of at least one of the first (100) and/or the second (200) shaft with the one or more cooling streams (91), heating the recirculated exhaust gas (40) with the one or more heated cooling streams (91) extracted from the upper portion (131, 231) of the cooling zone (130, 230) of the at least one of the first (100) and/or the second (200) shaft;
(e) separating air with an air separation unit (ASU) forming an Oxygen-enriched composition comprising at least 70% (dry volume) O2 and a Nitrogen-enriched composition comprising at least 80% (dry volume) N₂ and less than 19% (dry volume) O2 and feeding the at least one comburent (30, 31, 32) comprising the Oxygen-enriched composition in the preheating zones (110, 210, 310) and/or heating zones (120, 220, 320), wherein the air separation unit (ASU) is within a radius of 2 km from the multi-shaft vertical kiln (MSVK); and/or
(f) heating the exhaust gas extracted from the multi-shaft vertical kiln (MSVK) using a heater, in particular an electric heater, a oxyfuel burner or an indirect burner, and/or a heat exchanger transferring heat with the one or more heated cooling streams (91, 92) extracted from said kiln MSVK, in particular at an upper portion (131, 231) of said cooling zone (130, 230).
